(19) United States
(12) Patent Application Publication
(10) Pub. No.: US 2015/0350150 A1
(43) Pub. Date: Dec. 3, 2015

(54) System and Method for identifying and communicating with People and Business based on Proximity, Interest, availability, and a 16 view proximity based chat

(71) Applicant: Peter Wolfl, North York (CA)

(72) Inventor: Peter Wolfl, North York (CA)

(21) Appl. No.: 14/714,367

(22) Filed: May 18, 2015

Related U.S. Application Data
(60) Provisional application No. 61/994,863, filed on May 17, 2014.

(51) Int. Cl. H04L 12/58; H04L 29/08; G06F 3/0484; G06F 17/30; G06F 17/21

(52) U.S. Cl. CPC H04L 51/32; G06F 17/30882; G06F 17/212; G06F 17/30896; G06F 3/04842; H04L 67/02; H04L 51/18

(57) ABSTRACT

The invention provides a system and method that enables local people and business to know each other and communicate based on proximity search and filtered access to profiles, public chat and private chat. The invention also provides a system and method to incent, facilitate and manage viral expansion of members as existing members sponsor (recruit) non-members (people and/or businesses) to join.

### CROSS-REFERENCE TO RELATED APPLICATIONS

This application claims the benefit of U.S. Provisional Application No. 61/994,863, filed May 17, 2014.

### BACKGROUND OF THE INVENTION

The invention pertains to social networking, dating and communications. People do not know each other and it is getting worse every day as the world's population grows. One can live or work in a house or building for 20 years and not know the first names or interests of people next to them. When people don't know each other or have an easy way to communicate, they will not care, help or support each other. In worst case, this can be dangerous as people do not share information about threats. In best case, it is a large opportunity cost as people do not share knowledge and opportunities that could support each other. Most social networks focus on connecting members to people they already know, follow or had previous contact with. Most dating sites focus on connecting people based on looks, and they can be scattered all over the world with little regard to proximity and interest. There is a need for an integrated system that includes both socialization and dating with strangers within proximities close to their home, work, other address or current location. Additional filters including interests and availability should also be added. .

It is difficult for people to know others who live or work nearby. A solution is needed to enable people to identify, communicate and quickly learn about local people and businesses based on proximity, common interest and availability, for both socializing and dating, including within the same building and nearby.

Most social networks and dating sites depend on large quantities of members for them to be useful to new members. Some request access to member's address book to send invitations to non-members to join. There is a need for a system and method to facilitate and provide incentive for viral expansion of members based on member invitations to non-member people and businesses to join.

### BRIEF SUMMARY OF THE INVENTION

The invention provides an integrated system and method for people and business to know each other and communicate based on filtered access to profiles, public chat and private chat.

The invention provides a system and method for identification of people and business within a specified radius around a selection of base coordinates, using a combination of filters. Available base coordinates may include home, work, other address and current location (not necessarily tied to an optional GPS result). The purpose is to help people quickly learn about local people and businesses around them based on proximity, interest and availability for socializing and/or dating, including within the same building or within walking distance. Using one of the views called PEOPLE, the user can select a proximity (i.e. 2 miles) from a selected base coordinate (i.e. home, work, other address or current location), after first having entered these addresses in their Edit Profile and the system converting them and storing the coordinates (longitude and latitude). They can also select if they only want see the address of people's home, work, other address or location or a combination. If the No Duplicates button is checked, only the closest address to the logged in user will be shown. For example, a user may want to find a tennis partner within 2 miles from home and they don't care if it is someone's home or work that appears, but it should be the closer of the two. Several other filter options are available including: dropdown (stranger, contact, favorite, logged in user); [Interest, Occupation, First Name and/or Memo] [Exactly, Contains or Starts with] [Keyword]; {Male or Female]; online; can meet now; VIP; Picture. This allows a user to meet, communicate and stay connected with people near to a place where they normally spend time, regardless of where they currently are. To search for people within their building, they would set the proximity to zero (mi/km) which would show people having the exact same coordinate, or it could be set to 1 or 2 (mi/km) to show people within walking distance. Users can then scroll or flip through mini profiles of people from closest to furthest away so they can instantly know their names, first 3 interests, occupation, mood, how far away they are, and what city/country they live in. They then have the option to see their full profile or chat with that person publicly or privately. The dating, places, events and deals views work the same way.

The invention also provides a system and method for communication with people and businesses using a 16 view proximity based chat within a specified radius around the selection of base coordinates using a combination of filters. This enables members (people and businesses) to have non-stop public discussions about any topic in a selected language of their choice. A 16 view proximity based chat is used to organize the communication. By selecting a combination of people, category and subject for which to view chat, the user can filter chat in a hierarchical manner indicated by a selectable breadcrumb showing speaker, category and subject. Users can chat with the same selection of people or businesses that they can see identified in the People or Places views. The chat information is accessible 24×7 worldwide over the internet. Chat can be basic (similar to text messaging with only a comment input field) or advanced (which adds a category and subject to each post). The user can filter posts to only view the combination of people types (stranger, contact, favorite), categories, subjects, proximity, interest, first name, occupation, memo keyword, online status, availability to meet status, VIP status, and if they have a picture. This enables people and businesses to communicate and stay connected with other people and businesses based on proximity, common interest and availability, including within the same building and nearby. The private chat works in the same way.

The invention also provides a system and method to incent, facilitate and manage viral expansion of members. As members sponsor (recruit) non-members (people and/or businesses) to join, their username and a promotion code (if available and used by the member) are associated with the registration of the new member. If the new member pays a fee based on the promotion code or lack thereof, then the sponsor will be eligible to get credit for the sale. The sponsor will also be able to see the membership and payment status of members they have sponsored using a lookup view after logging into the system.

### DETAILED DESCRIPTION OF THE INVENTION

The mission of MeetMeHere.com (mmh) is to help people help each other. This actually has 3 meanings:

help people

help each other

help people help each other

This can be facilitated by a system and method in which users can identify and communicate with other users (both people and business) based on proximity, common interest and availability. A 16 view proximity based chat is included to facilitate and organize the communication. Users can meet other users that reside in the same building, on the same street, or within x (miles or kilometers) from their home, work or other address that they input into their profile. The information is accessible 24×7 worldwide over the internet.

Generally until now, to meet people near to where they live or work, one of the parties would need to approach the other and start some small talk. Then if one is assertive enough they may ask the other for their contact information so that they can communicate in the future. It has been difficult for people to meet (and then get to know) other people who live or work nearby. People can live in the same building or on the same street for 20 or more years without knowing their neighbors names or any interests they have.

With mmh, people could potentially know Picture+First Name+3 key interests about their neighbors before they meet them face-to-face for the first time, based on what they said about themselves in their profiles and what they said or say during public chat.

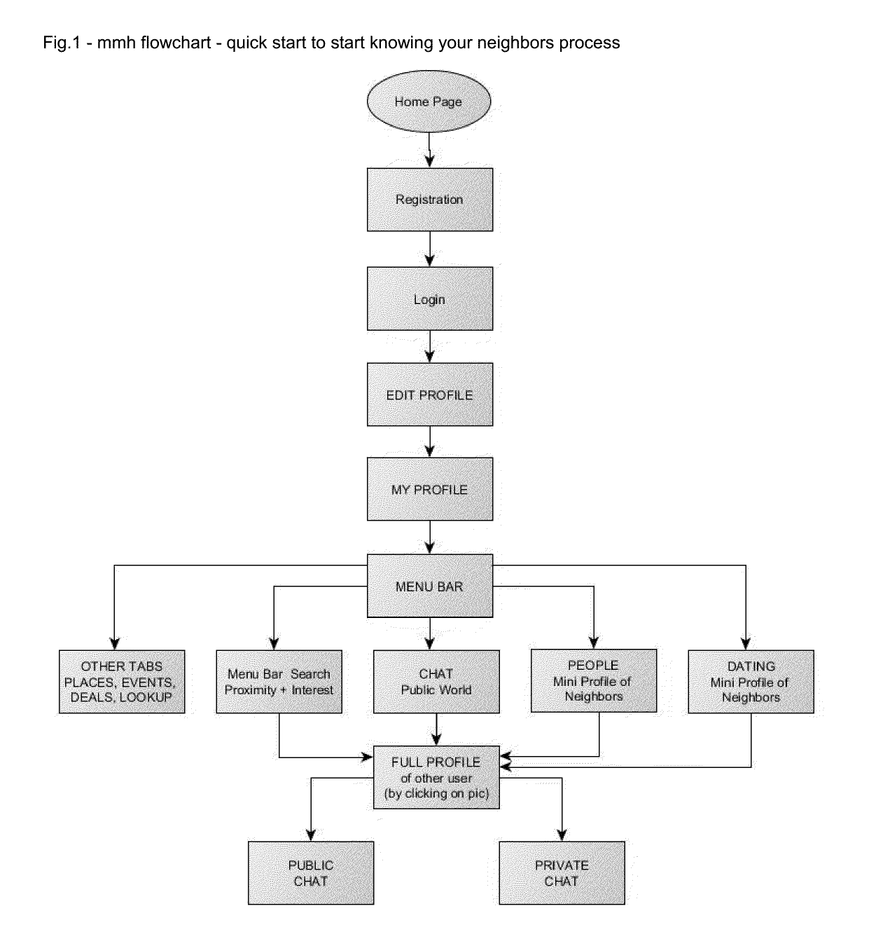

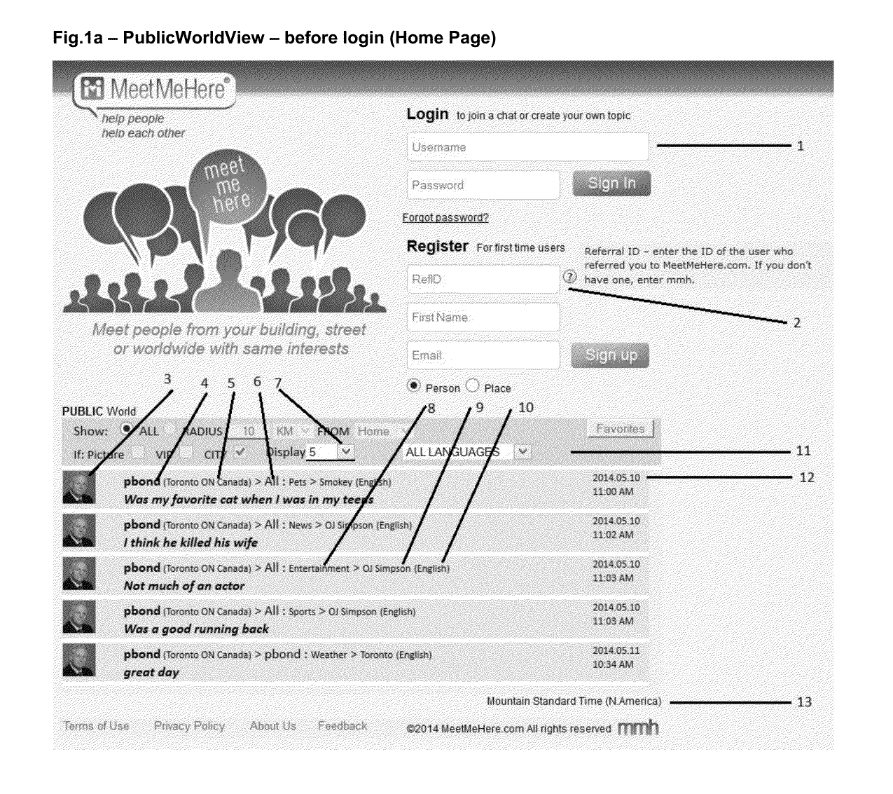

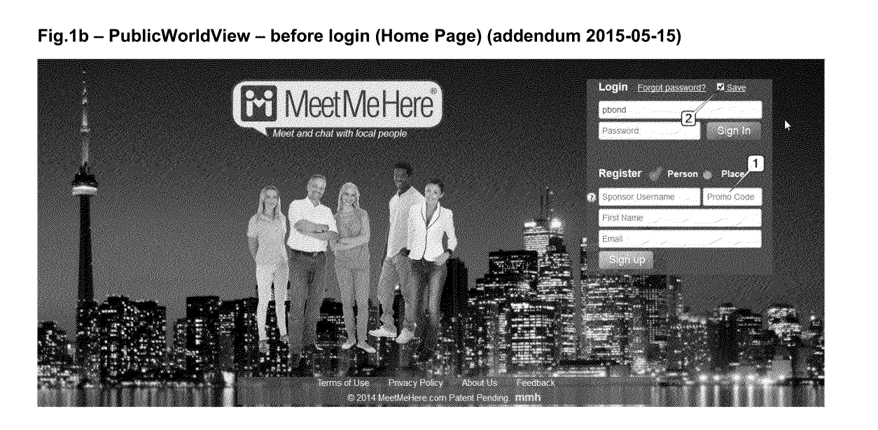

FIG. 1—mmh flowchart:—The process is summarized in FIG. 1 and is described in further detail below with reference to figures.

A Member introduces a Prospect to mmh through normal daily communication. This could be done in person, phone, email, fax, mail, etc. An example of an in-person introduction would be if a Member walks up to a Prospect and asks “Are you a member of meetmehere.com?” If YES, the Member says “Great. What's your username? Let's chat sometime”. If NO, the Member says “MeetMeHere.com is a great way to meet people in your building, on your street or worldwide with same interests. For example, you could find someone who wants to play tennis right now who lives nearby you. There's no cost to try it. I'm a member and I'm telling you about it because I believe in their mission which is to help people help each other. Only members can introduce new people. If you tell me your first name and email, you could get an email from MeetMeHere within a minute that gives more information. Interested?”

FIG. 1a—CHAT—PublicWorldView—before login (Home Page): Member can enter their userID (aka referral ID or RefID 2), along with the first name and email of the Prospect into their device (such as mobile, tablet, desktop) and click Sign up. mmh then immediately sends an email with general information, motivating reasons why people should join, and a registration link to the prospect.

After Prospect clicks on the registration link and fills in the registration form, they may receive an offer to join immediately as a VIP at a discount price or they can join as a free VIP member for one month trial. After submitting registration form, the prospect receives a welcome email that confirms their UserID and Password, and provides some quick start tips.

Prospect then proceeds back to login area on the homepage (aka Public World View before login) to sign in 1. On the homepage, Prospect can read what other users from around the world may be saying in various languages [this area has been removed in the latest version]. It shows the user picture 3, their userid 4, their city/state/country 5, who they are speaking to publicly 6, what category they are talking about 8, what subject they are talking about 9, what language that is in 10, on what date/time they said it 12 based on the server time zone 13 [this has been revised to the user's local timezone in the latest version]. The Prospect can filter to see only what is being said in a particular language 11. The Prospect has control over how many posts are displayed 7. If more than 5 posts are selected for display, then a scroll bar is visible and can be used on the right side. However, a Prospect cannot join the chat until they login.

FIG. 1b—CHAT—PublicWorldView—before login (Home Page) (addendum 2015-05-15): The Referral ID is now known as the Sponsor Username. When a non-member wishes to register, they may now also enter a promotional code 1 if they know it, which may result in them getting a special offer such as a discount on VIP membership. A member can now also click a Save checkbox 2. to save the username in a cookie so that next time they open to browser the username will still be there.

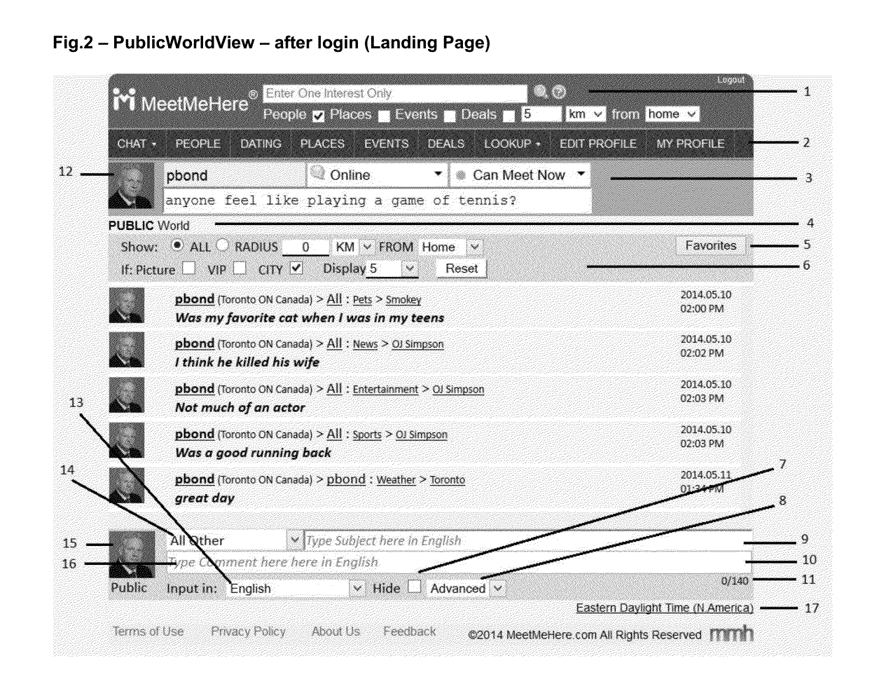

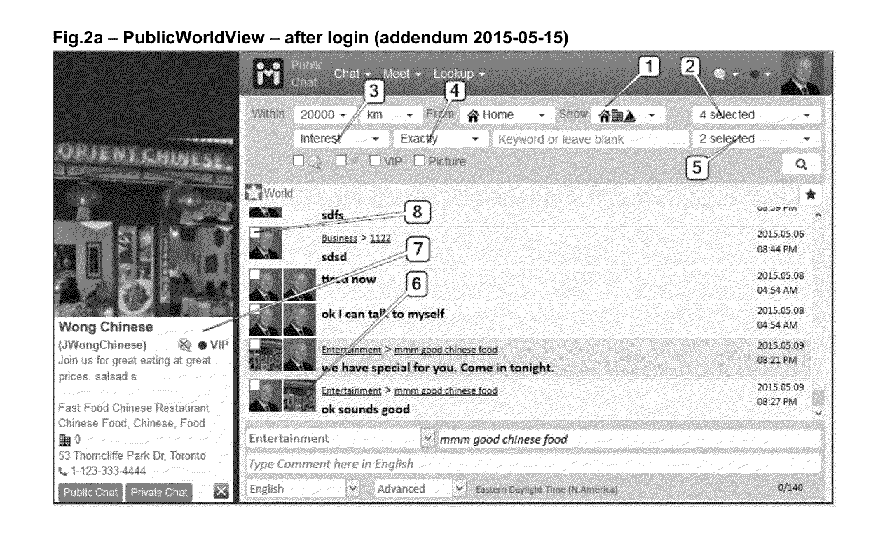

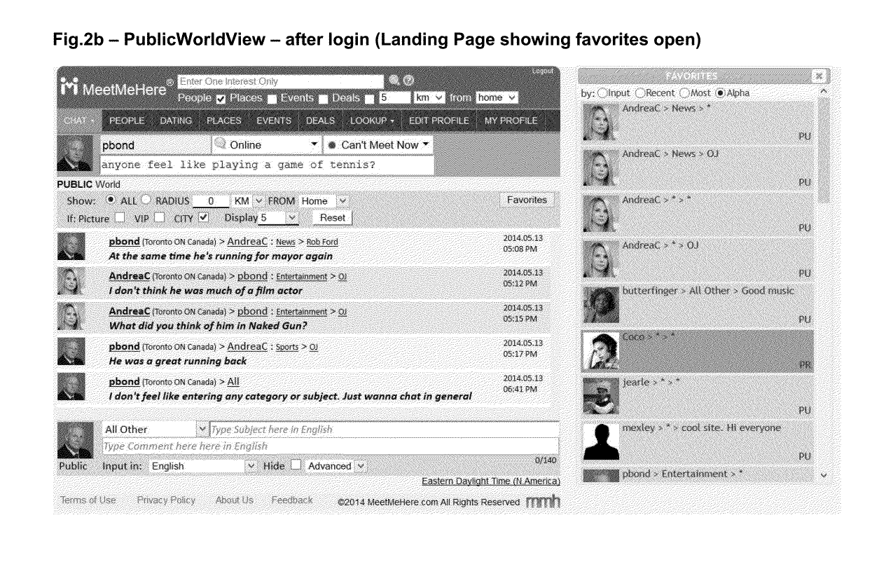

FIG. 2—CHAT—PublicWorldView—after login (Landing Page): Once they login, the Prospect (which we will now call a user, because they have registered and logged in) are on the landing page (aka Public World View after login) and they will see CHAT highlighted in the top left just below the logo. Above that, after the logo and trademark, they will see:

MENU BAR SEARCH CONTROLS 1 for doing a quick interest and proximity search for one or more of People, Places, Events, and Deals within a proximity from their home, work or other address [this has been removed in the latest version].

MENU BAR TABS: CHAT (Public, Private), PEOPLE, DATING, PLACES, EVENTS, DEALS, LOOKUP (UserID, Occupation, Favorites, Who made me a favorite?, Blocked users, Who blocked me?, My referrals, Who referred me?), EDIT PROFILE (where users add, edit and delete their profile information) and MY PROFILE (which shows user how others can see their profile) 2.

Upon first login, their picture will appear as a silhouette; however, after they add a main picture in Edit Profile, their pic will appear in the ID bar 12 next to their userID and where they can also see & set their online status (online, busy, away, do not disturb), availability 3 (can meet now, cannot meet now), and mood (i.e. “anyone feel like playing a game of tennis?)”. [this has been removed in latest version]

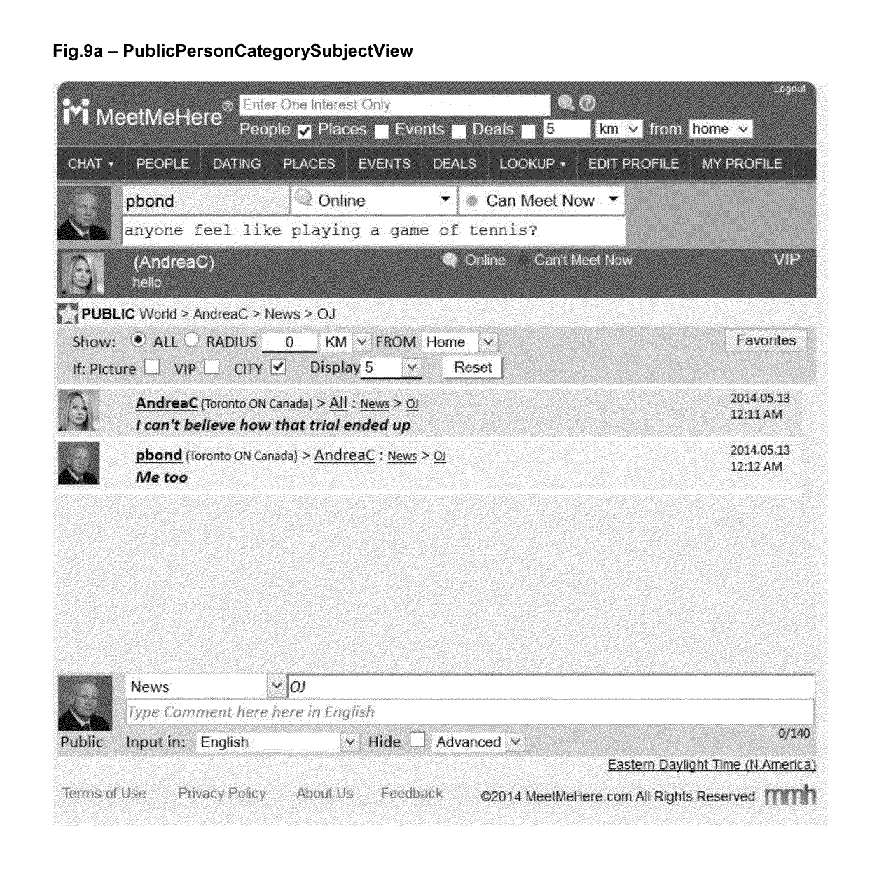

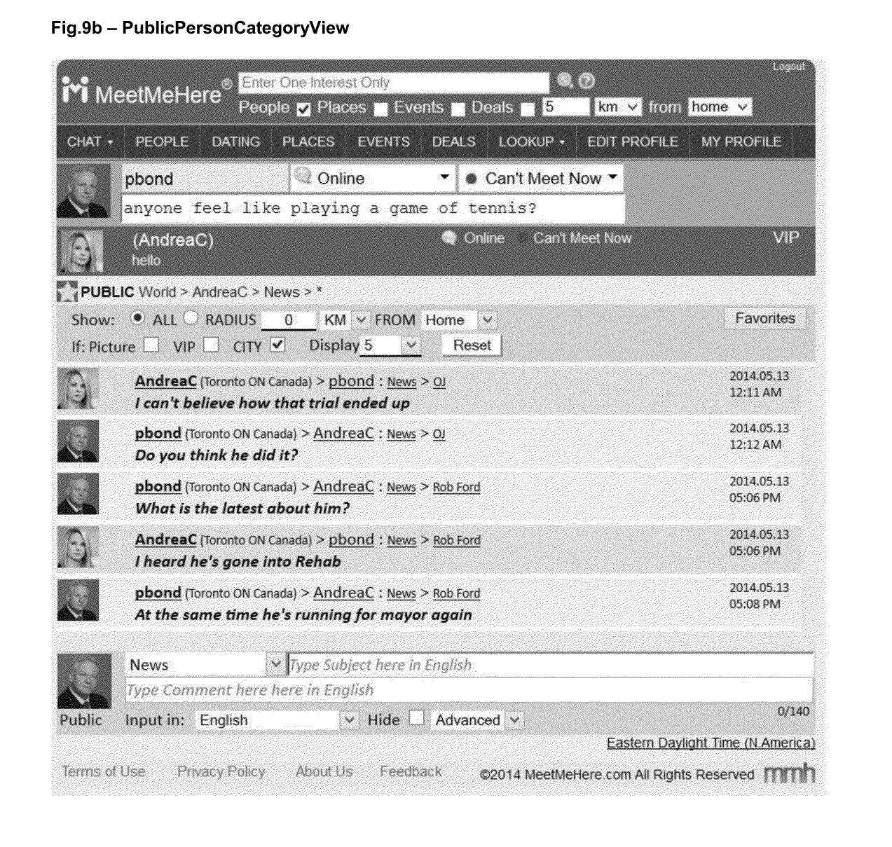

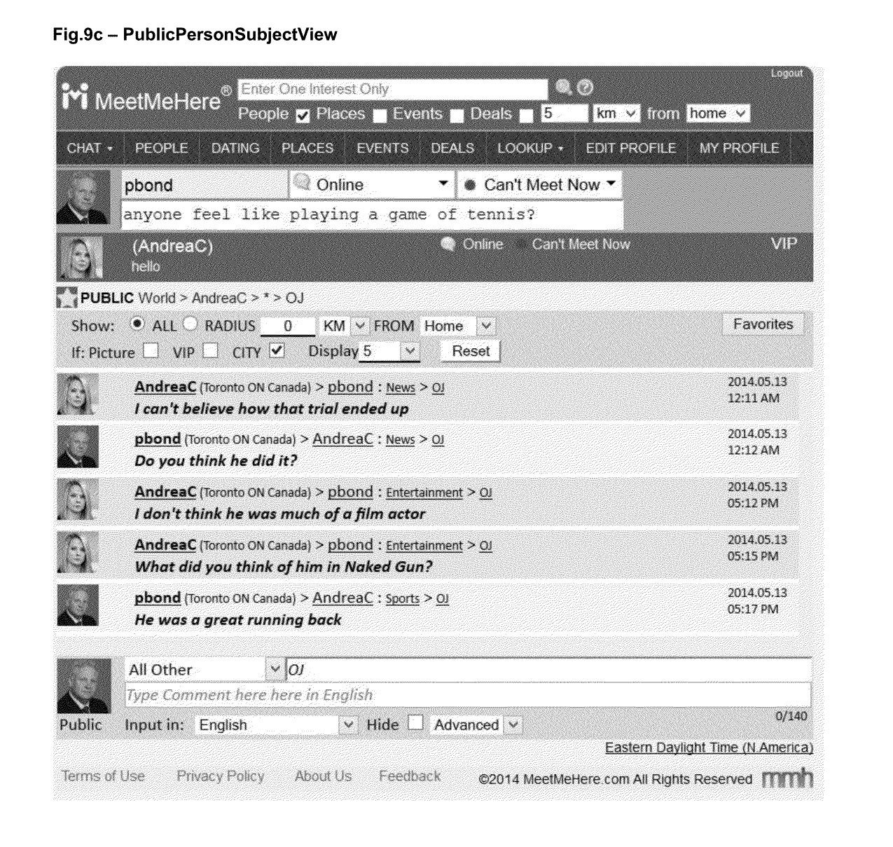

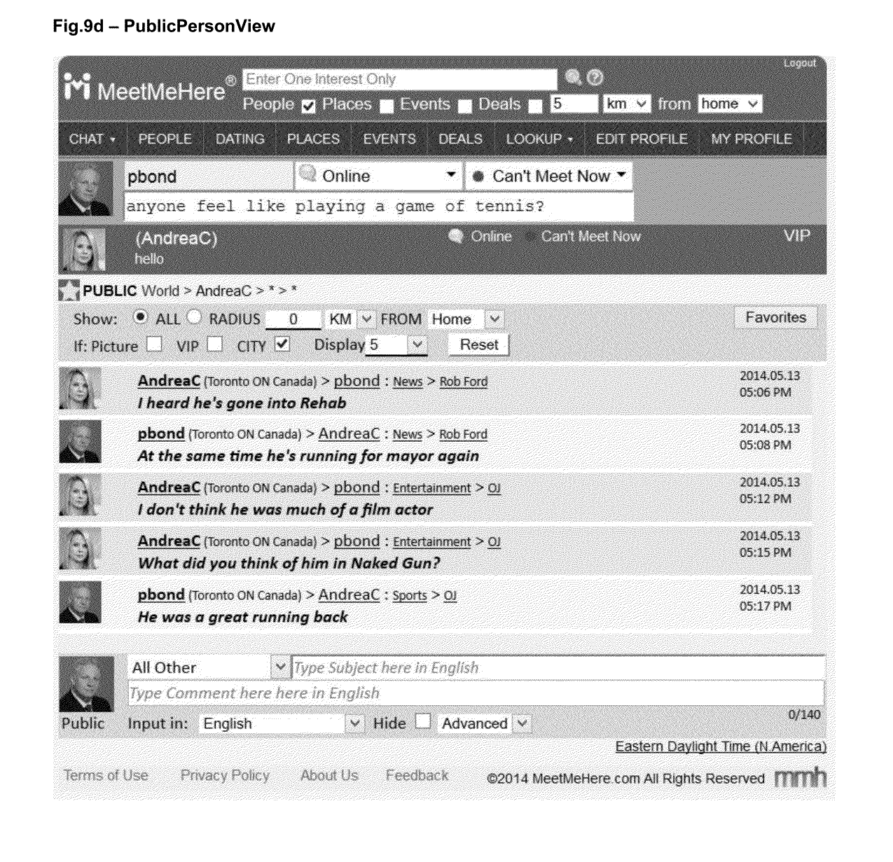

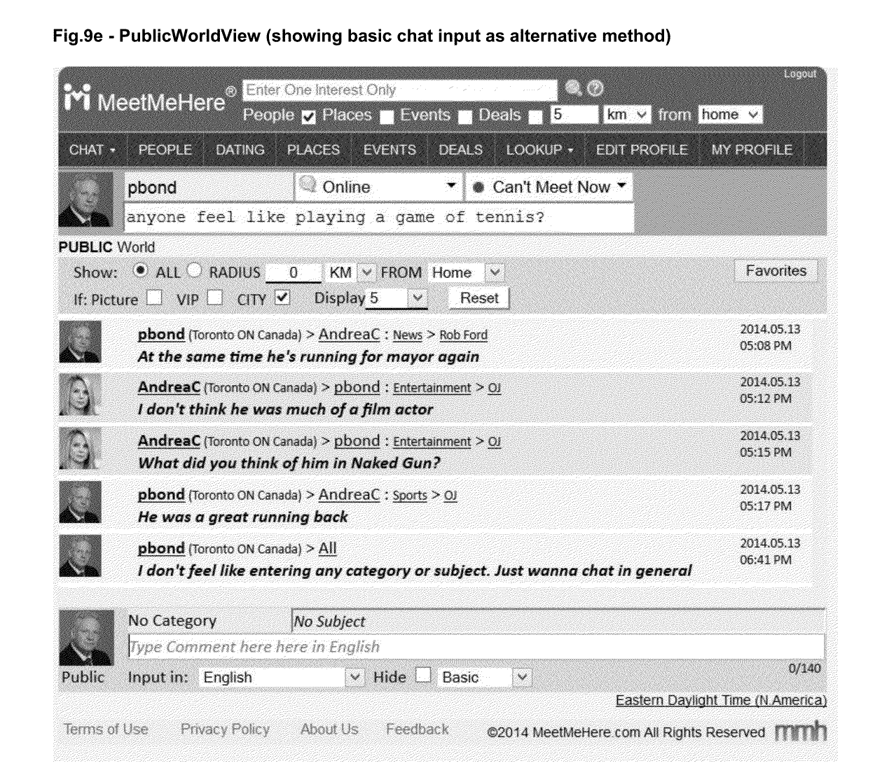

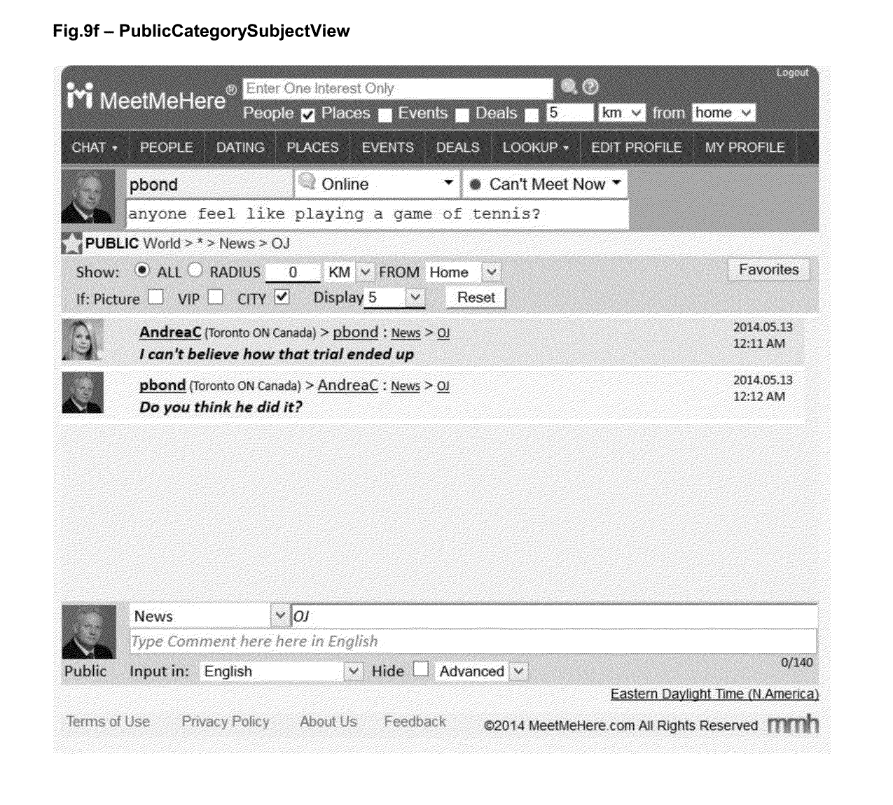

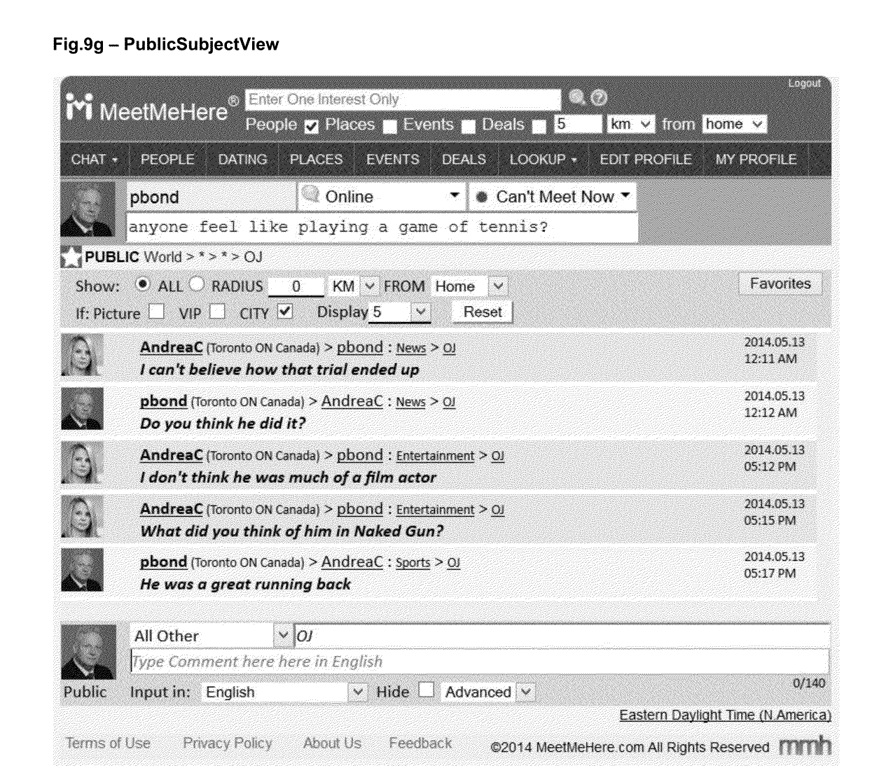

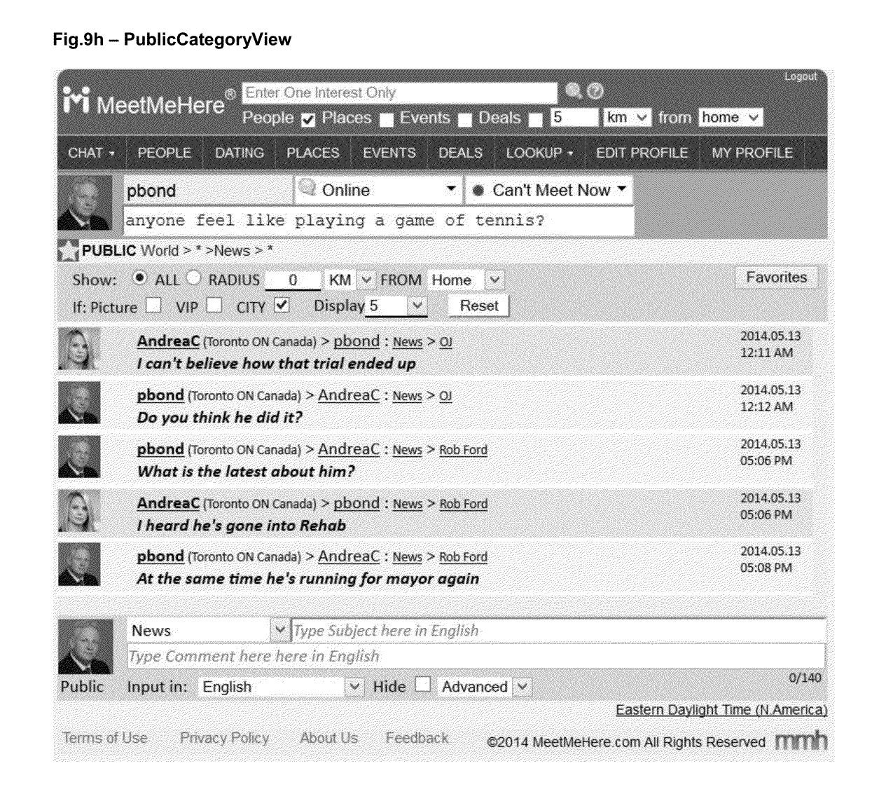

Below the logged in user's ID bar, is a breadcrumb bar. 4. This will help the user know what chat view they are looking at and provide navigation links. FIG. 9a gives another example of this and shows a star in front of the breadcrumb. When the star is clicked, the current view will either be listed or delisted from the favorites list (which can be viewed by clicking on the Favorites button in the rules bar below.

Below the breadcrumbs is the RULES BAR 6. Here they can select if they want to see ALL posts or only posts within a selected RADIUS. Radius can be any whole number, units can be kilometers or miles [in the latest version, the user only as the options of 0, 1, 2, 5, 10, 25, 50, 100 or 20000]. Any radius can be from Home, Work or Other address. The Favorites button will display the list of the user's favorite chat views so they can easily switch to them. This allows the user to conceivably have several conversations going on with several people at the same time. On the next line, user has options to select if only users with a main picture will be displayed, if only VIP members should be displayed, if City/State/Country should be displayed in posts. And how many posts should be filtered. The RESET button will change all the rules bar settings to the default settings which user can change at the bottom of EDIT PROFILE [this is removed in latest version].

Below the rules bar is the post area. Up to 5 posts are visible at one time as shown. In this case, pbond is chatting about pets, news, entertainment, sports and weather. For each post, the order is as follows:
pic, userid (city, state, country)>receiver: category>subject yyyy.mm.dd comment time

When pic is clicked, user will see PROFILE for that user [this was changed to mini-profile in latest version. Note that further details about the 16 possible views of CHAT is shown in FIG. 9.

Below the rules bar is the INPUT BAR. The order is: pic 15, category dropdown 14, subject 9 (up to 40 characters), comment 16 (up to 140 characters, including URLs to other websites in new window), Public or Private is indicated below the pic. Input language 13, Hide 7, Advanced or Basic input selector 8 (advanced includes category and subject with comment whereas basic does not), counter 11. On the next line is the time zone 17 that user has selected during registration and which can be changed in Edit Profile. Below that are links to Terms of Use, Privacy Policy, About Us, and a feedback form.

FIG. 2a—CHAT—PublicWorldView—after login (addendum 2015-05-15): shows some enhancements in the latest version. User may now click on Show dropdown 1 which gives option to select if the people chatting within the selected proximity are being considered based on their home, work, other address or current location or a combination of these. User may also select one or more of stranger, contact, favorite or themselves or a combination from the dropdown 2. They can also select one or more of Interest, Occupation, First Name, Memo, Category, Subject, Comment and UserName in the dropdown 3. The memo option is unique in that it gives the user unlimited group options when they enter keywords within the private memo (only visible and editable by logged in user) of other user's profiles. Dropdown 4 lets them select between Exactly, Contains, or Start with. Dropdown 5 lets them select one or more of People and Places. Instead of the FROM and TO usernames, these are now represented by Pictures of the FROM and TO users 6. When the picture is clicked, it opens a popup 7 which shows a summary of the user's status and gives option to see the full profile by clicking on First Name or Business Name shown directly under the picture, or clicking on Public Chat or Private Chat to go the that view with the selected user. Also added is a checkbox in the top left corner of the FROM user's picture 8 which when clicked opens another popup which includes options such as Reply, Edit, Delete, and copy selected category+subject to input area. Other options can be added in future such as report etc . . . .

FIG. 2b—PublicWorldView—after login (showing favorites open): shows favorites list which is displayed or hidden when clicking on the favorites button in the rules bar. The sort order the favorites can be selected as follows by: Input—most recently added is on top; Recent—most recently clicked is on top; Most—most often clicked is on top; Alpha—alphabetical order by person+category+subject

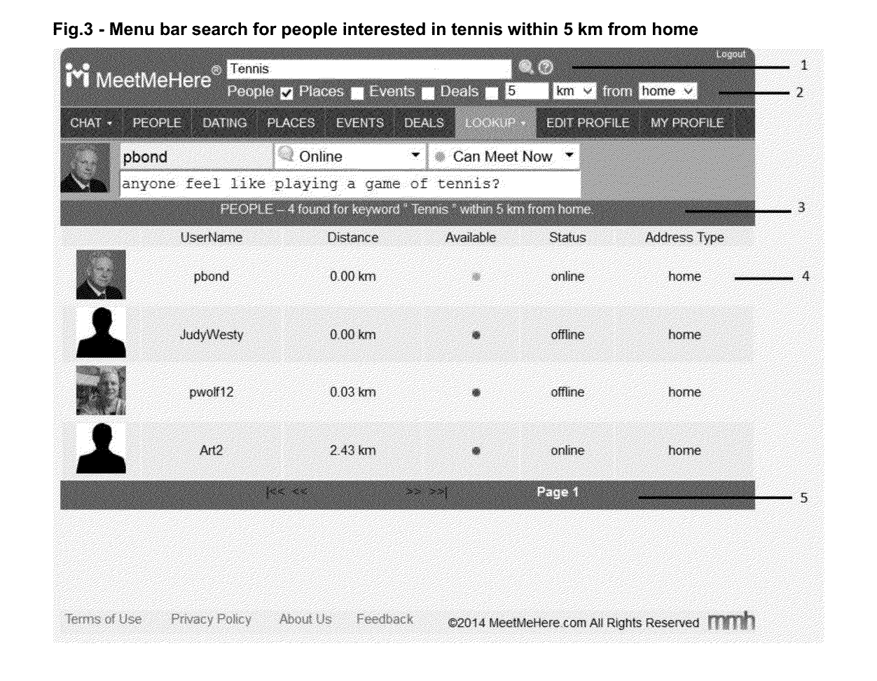

FIG. 3—Menu bar search for people interested in tennis within 5 km from home: shows user the output of a MENU BAR search. In this case, the interest 1 is entered along with People only within 5 km from home 2. The number of results found is listed in the title bar 3 and the results are shown below that 4. If there are more results than can fit on one screen, the pagination controls can be used to move between pages and see the page number 5. The user can select one or more of: People, Places, Events and Deals in the MENU BAR search controls 2 and the results would be shown in that sequence if selected.

Example of output if Places is selected:

3—PLACES—2 found for “Tennis” within 5 km from home

4—[Place Logo or Pic] Place Name, Place Description, Distance

Example of output if Events is selected:

3—EVENTS—2 found for “Tennis” within 5 km from home

4—[Event Pic] [Place or Person Pic], Event Headline, End Date, Distance

Example of output if Deals is selected:

3—DEALS—2 found for “Tennis” within 5 km from home

4—[Deal Pic] [Place or Person Pic], Deal Headline, End Date, Distance

When user clicks on any of the pics, they will see the full profile for the Place, Event or Deal. Given the format listed above, Events and Deals draw attention to the Place or Person that is organizing the Event or Deal.

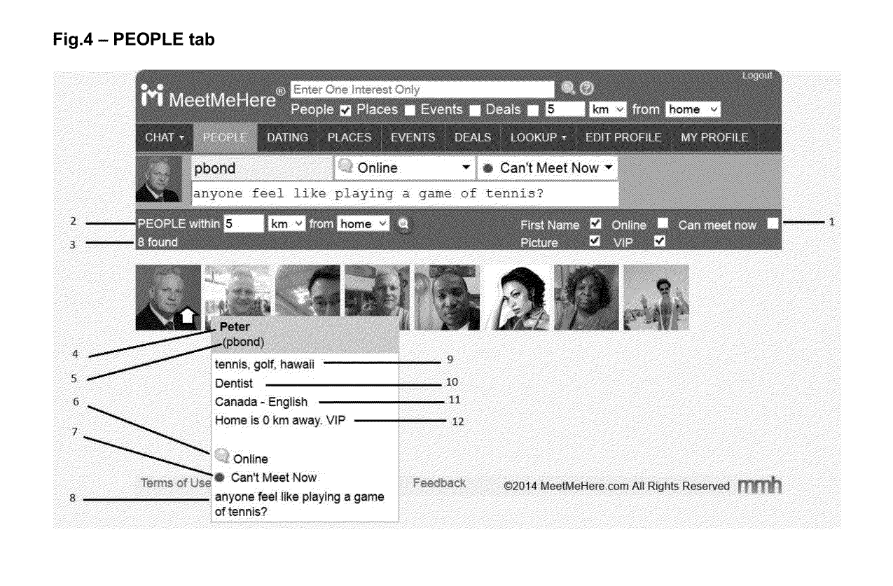

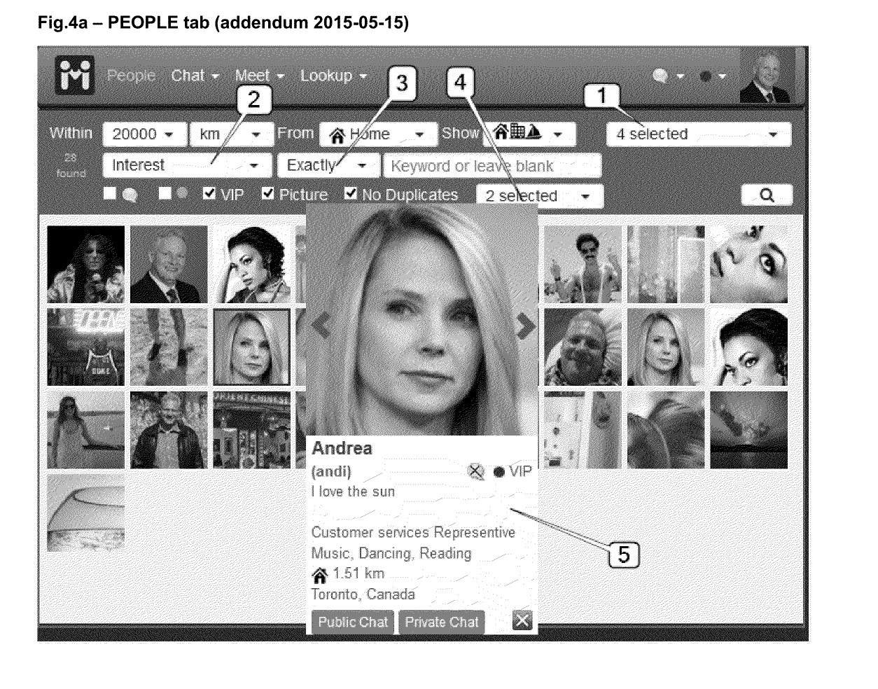

FIG. 4—PEOPLE tab provides a quick way for user to learn the names and key interests of their neighbors and associate it with their picture. This will give them something to talk about next time they meet in person somewhere. Similar to MENU BAR SEARCH or CHAT RULES BAR, the user can select to see only the results from PEOPLE with x km/mi from home/work/other 2 (in future, GPS will be added to this list). They can add further filters 1 by requesting to only see users who:

First Name—agreed to make their first name visible to others

Online—are currently online

Can meet now—who have set their status to Can Meet Now

Picture—who have a main picture uploaded

VIP—who are VIP members.

The number of people found based on the selected criteria is indicated 3. Below this will be a grid of pictures (uploaded pic or silhouette if no pic). These are sorted from closest to furthest away from the user. Capacity is 45 pics shown per page (9 columns×5 rows) but this may be adjustable by the user in the future. As the user hovers the mouse over a pic, that user's mini profile will appear which summarizes information as follows:

First Name (if user has permitted this in Edit Profile) 4

UserID 5

3 favorite interests (as identified in Edit Profile) 9

Occupation (if user has permitted this in Edit Profile) 10

Country of Birth—Main Language spoken 11

(Home/Work/Other) is x (km/mi) away. Membership status 12

Online status 6

Can meet now status 7

Mood 8

If there is more than one page, the pagination at the bottom will say: Page x of y 1 2>GoTo______. This allows user to click on a page number or enter a page number and click GoTo.

FIG. 4a—PEOPLE tab (addendum 2014-05-15) shows some enhancements. User may select one or more of stranger, contact, favorite or themselves or a combination from the dropdown 1. They can also select one or more of Interest, Occupation, First Name, Memo in the dropdown 2. Dropdown 3 lets them select between Exactly, Contains, or Start with. Dropdown 4 lets them select one or more of Male and Female. When the picture is clicked from the grid it opens a popup 5 which shows a summary of the user's status, how far away they are and which address is that distance away (home, work, other, location) and gives opens to see the full profile by clicking on FirstName shown directly under the picture, or clicking on Public Chat or Private Chat to go the that view with the selected user.

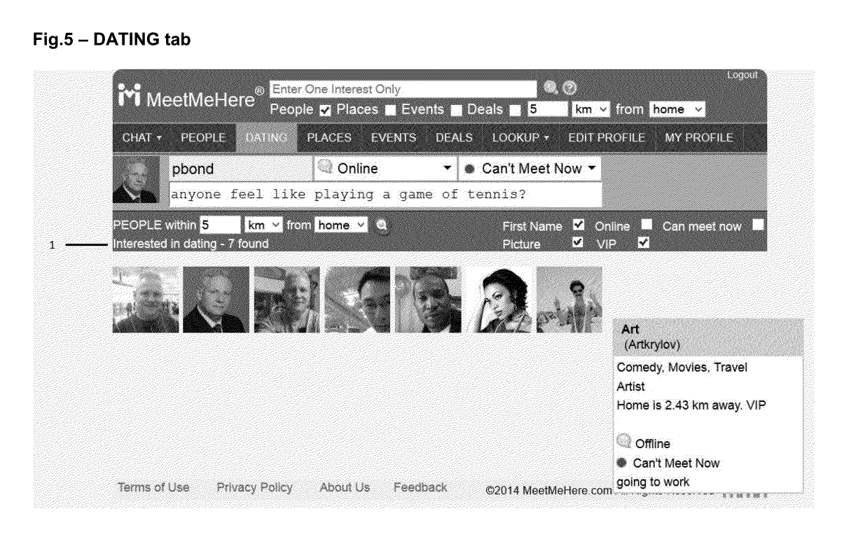

FIG. 5—DATING tab. This is the same as PEOPLE except that it is a subset of the neighbors that have indicated Dating=yes in EDIT PROFILE. The number found to be interested in dating based on the selected controls is indicated 1. Not shown yet are advanced filters that will allow user to filter based on sexual orientation (interest in male, female, both), age range (if user has agreed to disclose age), and relationship interest level (marriage, relationship, dating, casual).

PLACES, EVENTS and DEALS will have same layout as PEOPLE and DATING except that the Pics will be the PLACES PIC, EVENT PIC or DEAL PIC. And the contents of the mini profile (shown when mouse hovers over the pic) will be different as follows:

PLACES

Place Name

(Place ID)

Type of Place

3 keywords that describe the place

Brief description of offering

Distance Away. Member type (ECO or VIP)

EVENTS

Event Headline

Start Date/Time to End Date/Time

Location (Address)

Organized by [Place or Person ID]

3 keywords that describe the event

Category of Event

(Home/Work/Other) is x (km/mi) away.

DEALS

Deal Headline

Start Date/Time to End Date/Time

Location (Address)

Organized by [Place or Person ID].

3 keywords that describe the deal

Category of Deal

(Home/Work/Other) is x (km/mi) away.

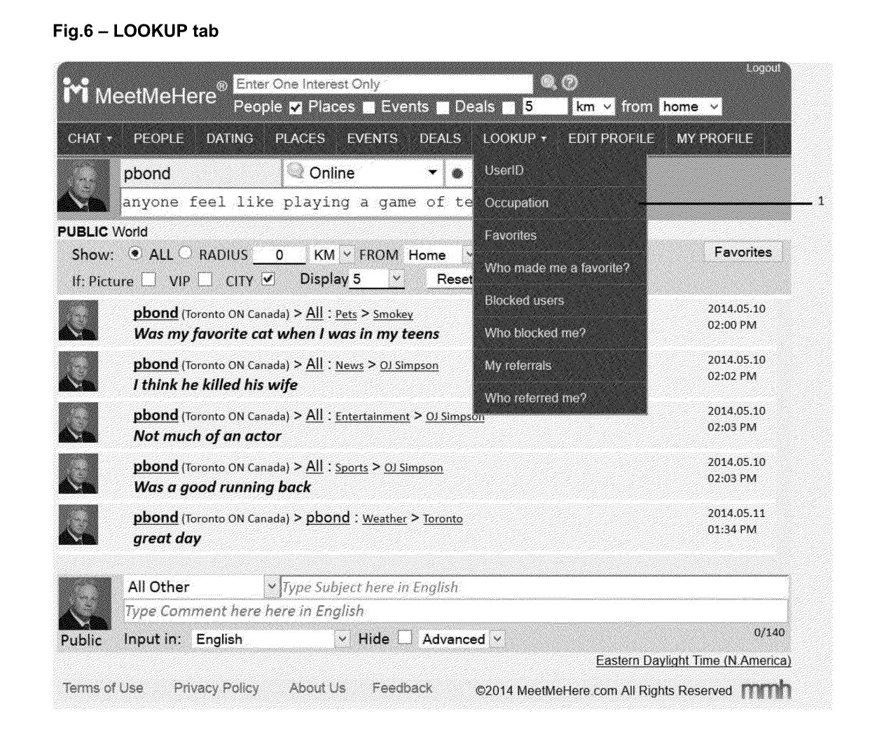

FIG. 6—LOOKUP tab. This tab shows dropdown 1 to lookup/find users as follows:

UserID—when userID is found, it opens to their profile.

First Name (not shown)—when first name is found, it shows list of options.

Last Name (not shown)—when last name is found, it shows list of options

Occupation—when last name is found, it shows list of options

Favorites—shows the user's favorites. Can be sorted by most frequent click or closest distance.

Who made me a favorite?—shows who made the logged in user a favorite

Blocked users—shows who the user has blocked. They can be unblocked from their profile.

Who blocked me?—this will be deleted. Instead users and their chat will just be invisible to the blocked user.

My referrals—shows who user introduced via their RefID. Shows membership status and when joined.

Who referred me?—shows profile of user that introduced logged in user.

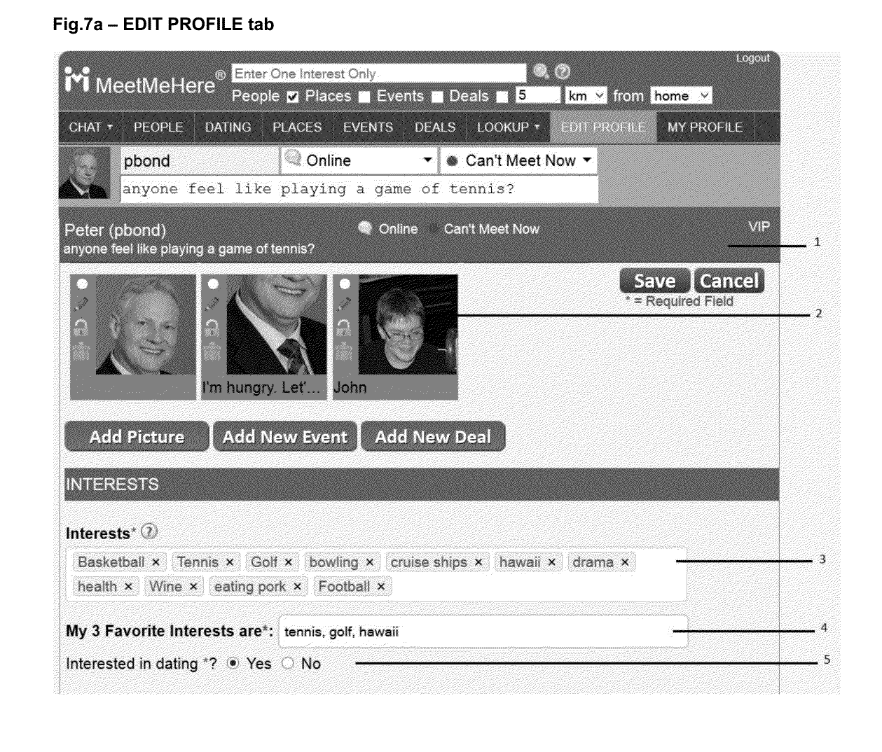

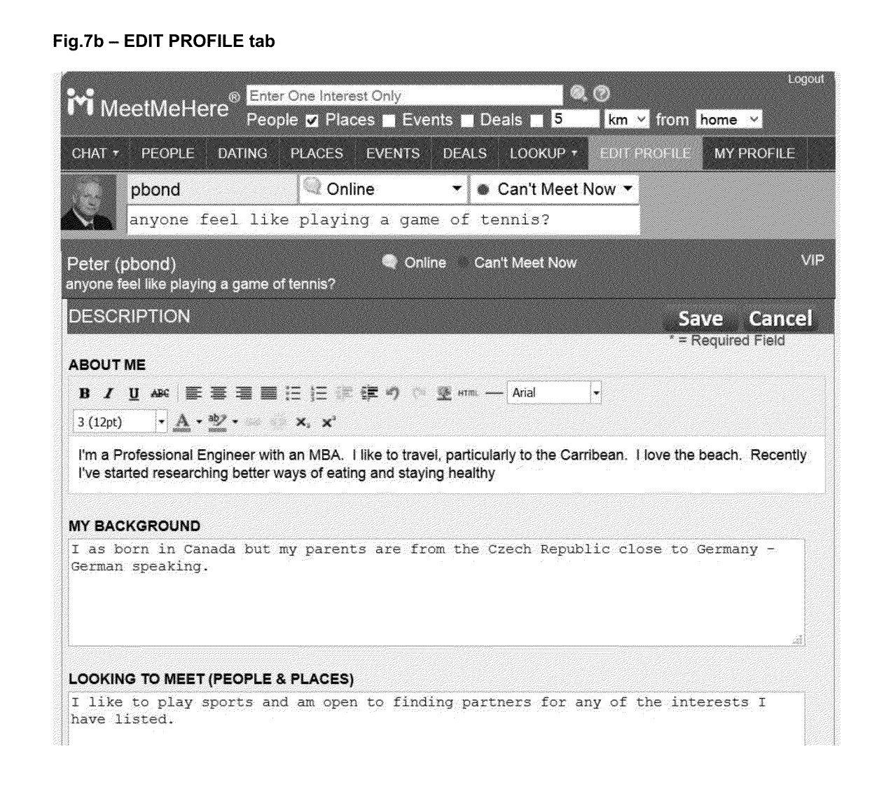

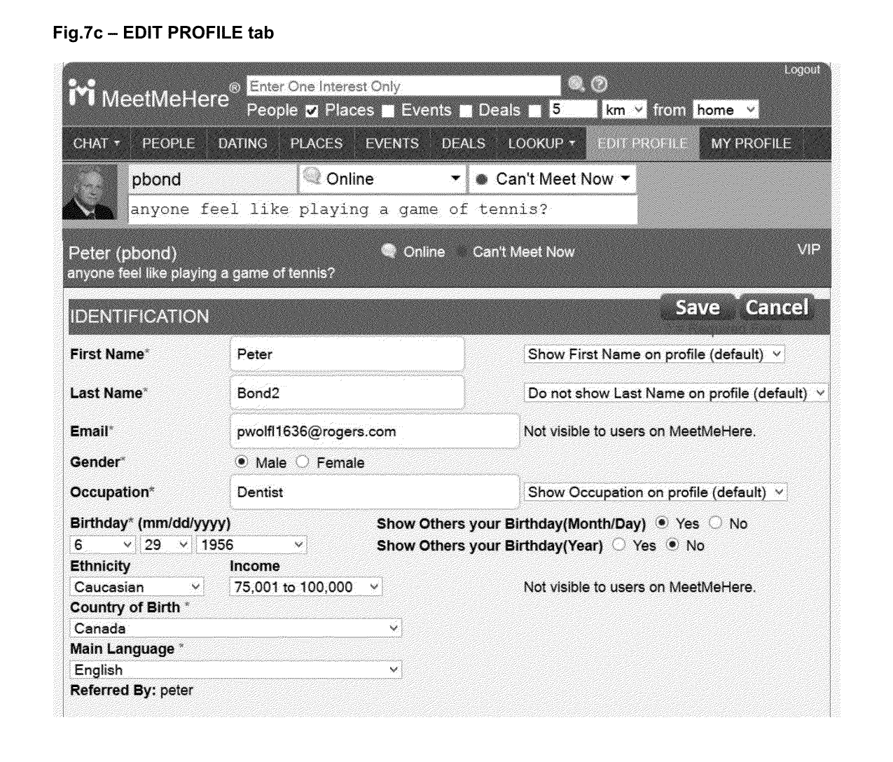

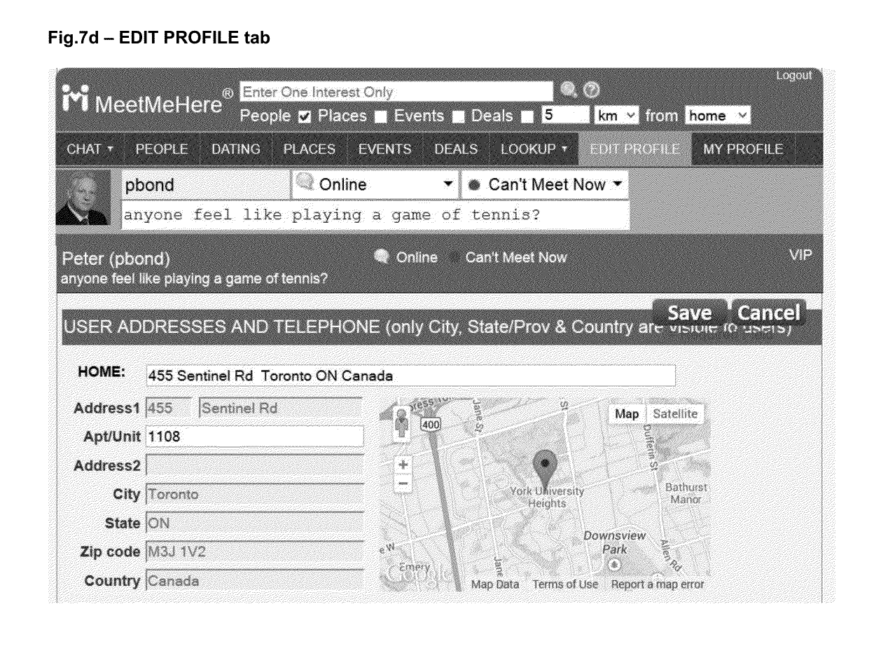

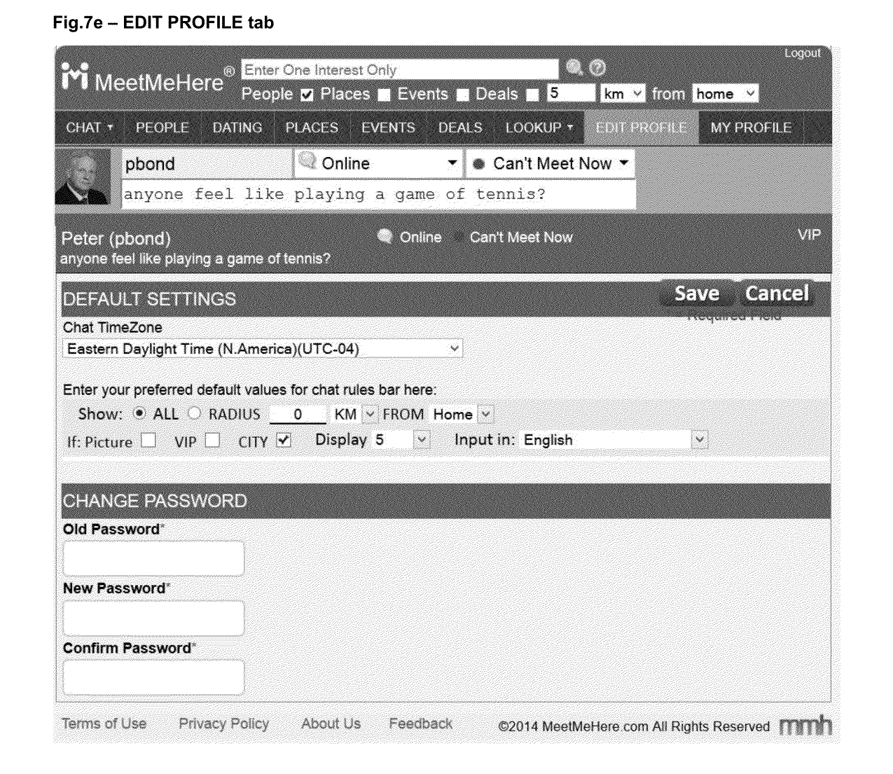

FIG. 7a—EDIT PROFILE tab. When user clicks on EDIT PROFILE in menu bar, they have the ability to add/edit/delete their personal settings and information that they wish to have displayed or don't want displayed. The order is as follows:

Summary of user status 1

Pictures 2 that user has uploaded along with caption. To the left of each pic is a radio button to select which pic is the main pic, an edit button, a lock button, and a trash button. Lock will enable or prevent a pic to be visible to others. Trash will discard pic. When edit button is clicked, user has thumbnail editor to adjust size of square thumbnail to be visible, to rotate pic, and/or add caption.

Interests 3 are a required entry for one or more. Any word or group of words may be entered here. Of these interests, we request user to enter 3 of their favorite interests 4 so that these can be displayed in mini profile.

If user is interested in dating, they can indicate yes here 5 and then their pic and mini profile will be visible in the dating tab.

FIG. 7b—EDIT PROFILE tab—user may enter additional details about themselves in ABOUT ME, MY BACKGROUND, and LOOKING TO MEET fields.

FIG. 7c—EDIT PROFILE tab—Identification information is shown in this section as shown.

FIG. 7d—EDIT PROFILE tab—In the address section, the user will see their home address which they entered in registration form but they may edit it here. The same layout will be shown for WORK and OTHER addresses so that user may enter or edit this information. In each case (home, work, other), the map updates immediately so that user can confirm that the correct address was entered which is very important because proximity searches are based on these addresses. This is followed by fields for home, work and cell phone numbers that may be entered but are not mandatory (not shown in FIG. 7d).

FIG. 7e—EDIT PROFILE tab—shows the Chat Time zone for the user. Also shown are default settings for rules bar in CHAT. These settings are used upon login or when reset button in rules bar is pressed. If user needs to change their password, this can be done here.

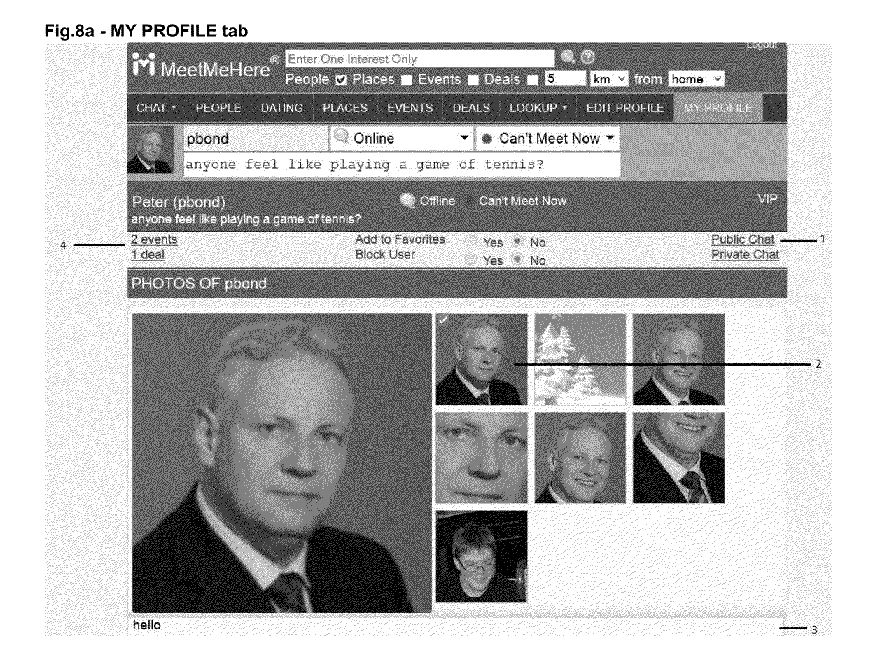

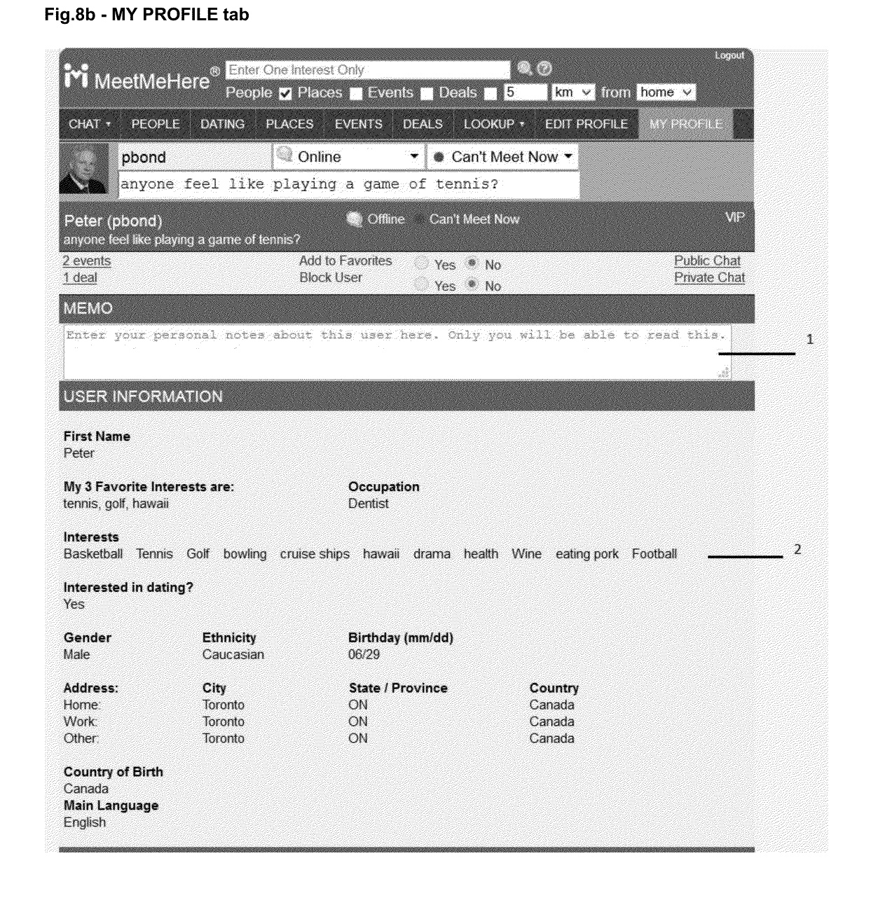

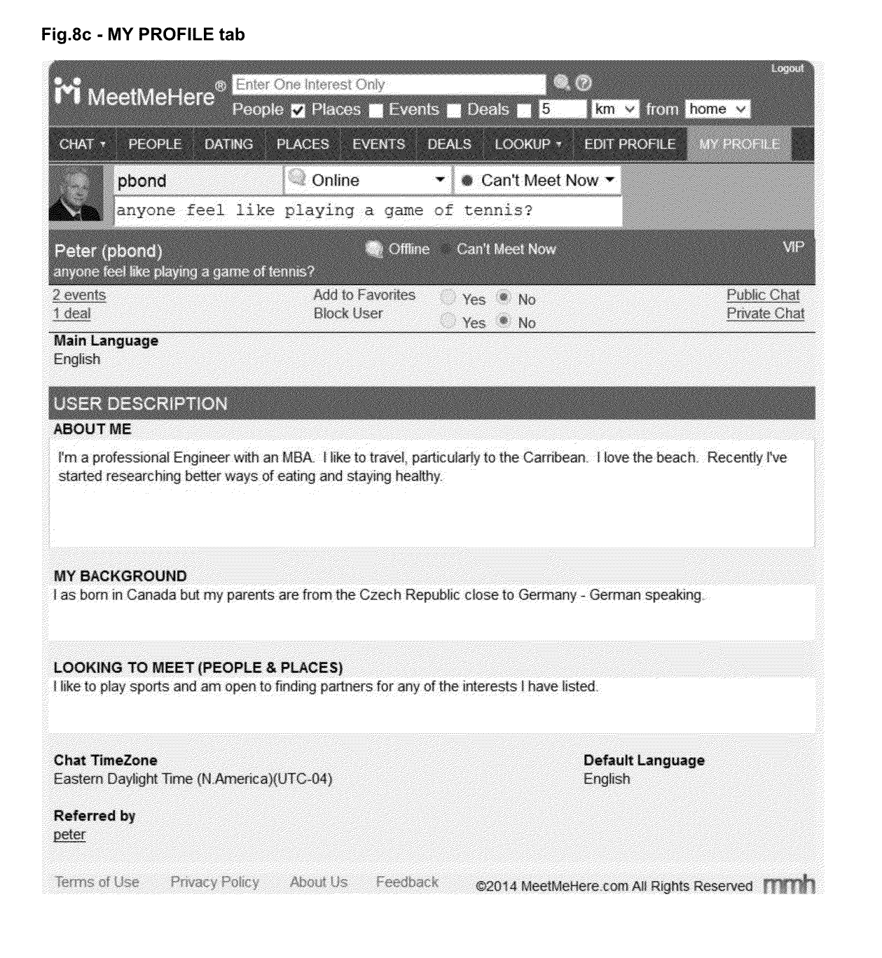

FIG. 8a—MY PROFILE tab—when user clicks on MY PROFILE, they will see how their profile will look to other users (via clicking on user's pic in CHAT, PEOPLE or PLACES or finding them via lookup UserID). A summary of the user's status is displayed followed by controls for entering into Public or Private Chat with them 1, controls for making user a favorite or blocking them, and links to see that user's events or deals 4. User's uploaded pics are displayed and by clicking on smaller pics 2, the larger one will be displayed, and by clicking on larger one, the full pic will be displayed and it will be hidden when clicked again. The caption for the large pic is shown under the large pic 3.

FIG. 8b—MY PROFILE tab—when user looks at another user's profile, they can enter a private note about that user 1. This is followed by user information as shown. When user clicks on any of the interests, they open a search for other users having same interests sorted from closest to furthest away and showing status information. Private information is not disclosed.

FIG. 8c—MY PROFILE tab—user description information, who referred them to mmh, default language for chat, and chat time zone are indicated here.

16 Views of Chat—this is a unique form of chat that is made possible by adding 2 more potential fields to each comment (category and subject), and each post can be public or private. The 16 possibilities are described as follows (indicated by the breadcrumb—FIG. 2 (4)):

| Sample Breadcrumb | Meaning | View Type |
|---|---|---|
| World > AndreaC > News > OJ | AndreaC said about News-OJ | PublicPersonCategorySubjectView |
| World > AndreaC > News > * | AndreaC said about News | PublicPersonCategoryView |
| World > AndreaC > * > OJ | AndreaC said about OJ | PublicPersonSubjectView |
| World > AndreaC > * > * | AndreaC said | PublicPersonView |
| World | All said | PublicWorldView |
| World > * > News > OJ | ALL said about News-OJ | PublicCategorySubjectView |
| World > * > * > OJ | ALL said about OJ | PublicSubjectView |
| World > * > News > * | ALL said about News | PublicCategoryView |
| World > AndreaC > News > OJ | I talk with AndreaC about News-OJ | PrivatePersonCategorySubjectView |
| World > AndreaC > News > * | I talk with AndreaC about News | PrivatePersonCategoryView |
| World > AndreaC > * > OJ | I talk with AndreaC about OJ | PrivatePersonSubjectView |
| World > AndreaC > * > * | I talk with AndreaC | PrivatePersonView |
| World | I talk with all private | PrivateWorldView |
| World > * > News > OJ | I talk with All News-OJ | PrivateCategorySubjectView |
| World > * > * > OJ | I talk with ALL about OJ | PrivateSubjectView |
| World > * > News > * | I talk with ALL about News | PrivateCategoryView |

The following figures (FIG. 9) are the 8 views of PUBLIC chat (one on many). The 8 views of PRIVATE chat are not shown because they would be the same except they would be for private conversations (one on one). Private chat will be available to VIP members only while public chat is available to all members. VIP members will be required to pay an annual membership fee. VIP members will receive a referral fee from each of their referrals that become paid VIP members. Non VIP members (called ECO for economy) will receive a percentage credit toward a VIP membership to each of their referrals that becomes a paid VIP member. These are illustrated in the following figures:

FIG. 9a—PublicPersonCategorySubjectView

FIG. 9b—PublicPersonCategoryView

FIG. 9c—PublicPersonSubjectView

FIG. 9d—PublicPersonView

FIG. 9e—PublicWorldView (showing basic chat input as alternative method)

FIG. 9f—PublicCategorySubjectView

FIG. 9g—PublicSubjectView

FIG. 9h—PublicCategoryView

In addition to Public and Private chat, there will be a third option called GROUP chat which is the same except they would be for group conversations (many on many, all who are members of the group). Only VIP members will be able to form groups and they can decide if group will be public (anyone can join) or private (offer and acceptance to join).

Mobile and App versions of mmh will work similar to the desktop version described above with the main difference being the layout so that it is easier to work with on smaller devices which are designed to be used in profile layout as opposed to landscape layout. The following figures illustrate how these will look and work:

FIG. 10—WVBLI mobile—this is the home page (worldview before login)

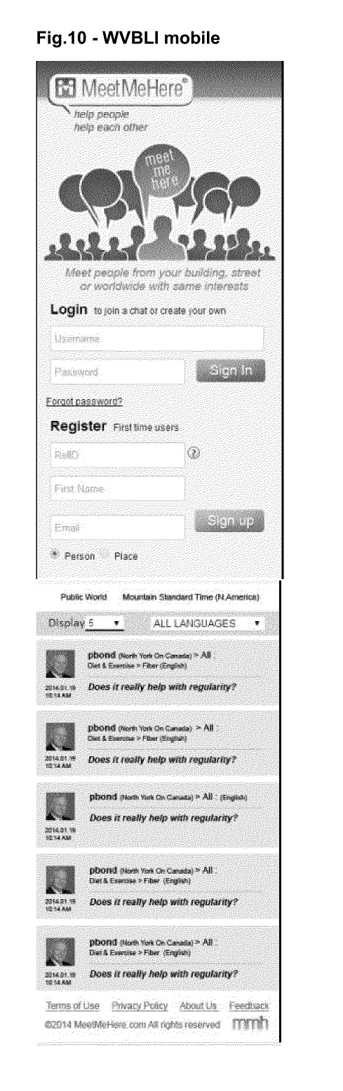

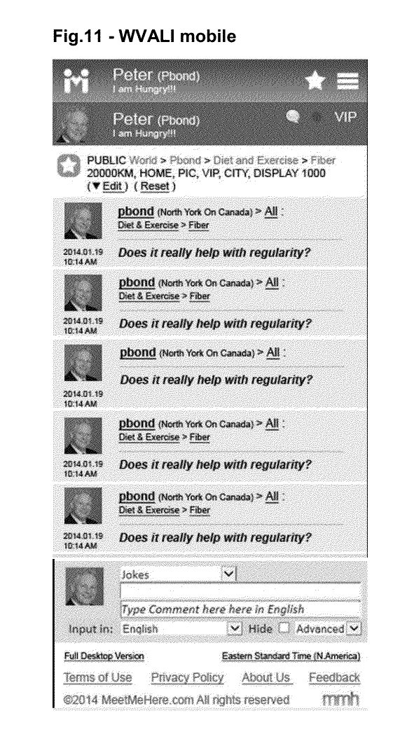

FIG. 11—WVALI mobile—this is the landing page (worldview after login)

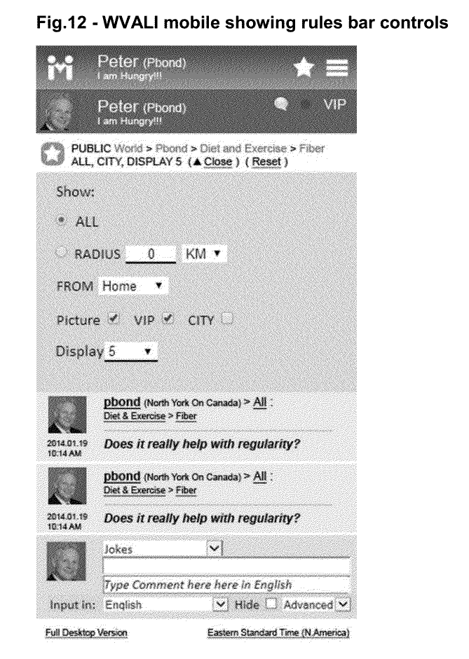

FIG. 12—WVALI mobile showing rules bar controls—click edit in FIG. 11 to see these rules bar controls and then click close to remove these controls and return to how it looks in FIG. 11.

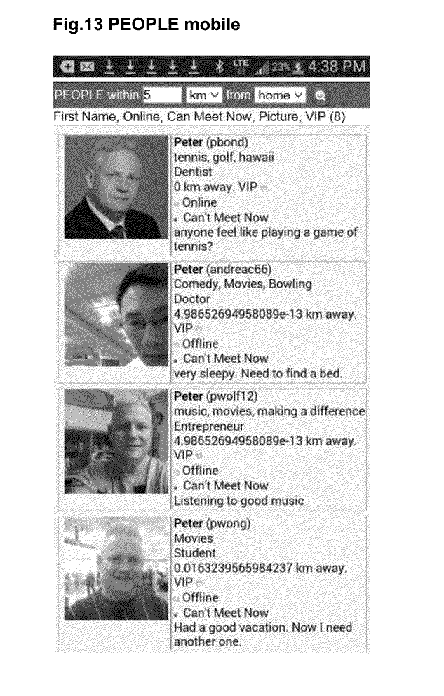

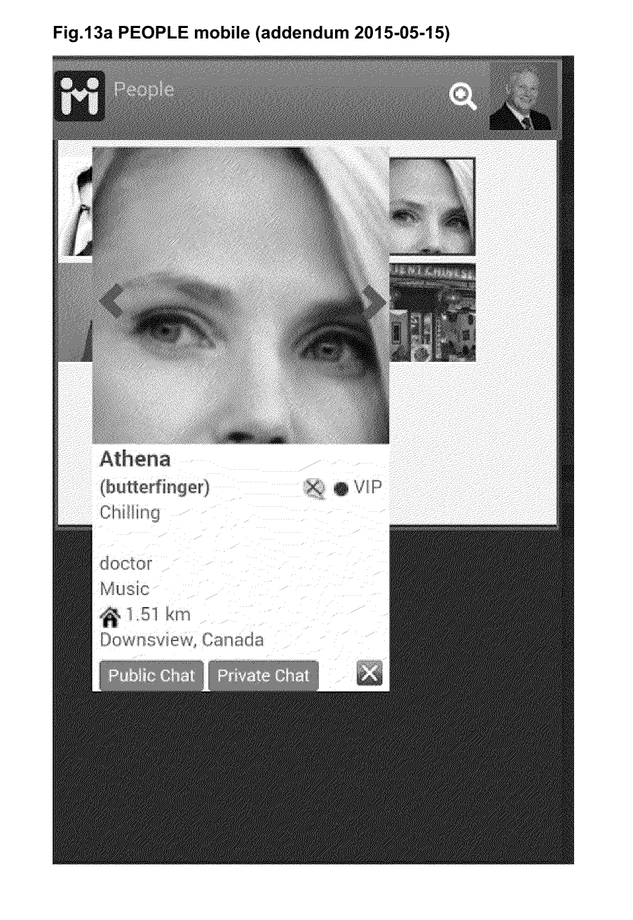

FIG. 13—PEOPLE mobile—scroll up and down to see more users that match selected criteria.

FIG. 13a—PEOPLE mobile (addendum 2015-05-15)—given the responsive design, this view has changed to be a grid just like desktop version. The filter area appears as a popup when the hourglass symbol in the menu bar is clicked.

1. A method and system that enables local people and business to know each other and communicate based on proximity search and filtered access to profiles, public chat and private chat, comprising:
registration of a new user by receiving user-defined information on a home web page or application that identifies their sponsor (if any), promotion code (if any), whether they are a person or place, their first name (if person) or business name (if place), and their email address;
user clicks Sign up button;
sending the user an email with a link to a registration page;
user clicks on link within email to be directed to a registration page that has first name (or business name) and email already filled in;
in the registration page, user input of their gender (if person), home address (if person) or work address (if place), Birthday (if person) with options to show mm/dd and/or yyyy, default timezone (if different from suggested timezone based on address input above), default language, username, password, accepting terms, and clicking on create account;
user logging in by inputting username and password and clicking Sign in
user being automatically directed to their Edit Profile page(on first sign in) to input one or more pictures and selecting one as main picture (if picture is not input, then a silhouette is provided), one or more interests, first name (if person) or business name (if place), gender (if person), occupation, birthday (if person) and other optional inputs

2. The method of claim 1, further comprising:
while in Edit Profile, inputting or editing home address, work address, other address and/or current location address then clicking Save;
determining the coordinates (longitude and latitude) of the addresses and storing them in a database;
user being automatically directed to My Profile page where they can view how their profile will look to other users
user may enter a private note to themselves in MEMO that is not visible to other users;

3. The method of claim 1, further comprising:
user may use Menu or a link at bottom of My Profile to navigate to other pages that include Public Chat, Private Chat, People, Dating, Places, Events, Deals, and Edit Profile;
menu changes to a hidden filter for devices having small screen sizes;

4. The method of claim 3, further comprising:
if user navigates to People, Dating, Places, Events or Deals, user will see pictures of the related people, businesses, events or deals sorted from closest to furthest away;

5. The method of claim 4, further comprising:
user will be given input options for finding members, events or deals that include: distance, units of distance (mi/km), base location for proximity search (home, work, other or location), Show dropdown [home, work, other or location address locations to be displayed], user type (Stranger, Contact, Favorite, and/or themselves), dropdown [Interest, Occupation, First Name, Memo], dropdown [Exactly, Contains, Starts with], keyword, dropdown [male, female], online (y/n), can meet now (y/n), VIP (y/n), picture (y/n), no duplicates (y/n) which shows only closest of all Show options if selected else it shows all Show options which may have duplicates, and search button;

6. The method of claim 4, further comprising:
if user clicks on a picture, they see the mini profile of that member, event or deal, that includes data such as name, username, online status, can meet now status, membership status, mood, occupation (if disclosed), one or more interests to fit one line, distance away and symbol [home, work, other, location], city, country, public chat button, and private chat button; by clicking on first name, user is directed to the full profile of that member, event or deal, or by clicking on Public Chat or Private Chat, user is directed to that type of chat with that person or organizer;

7. The method of claim 6, further comprising:
user may quickly browse through the pictures and related mini profile by using arrow keys on keyboard or swiping with touch screen devices;

8. The method of claim 6, further comprising:
when viewing the full profile of another member, the user may input and edit the private MEMO associated with that member;

9. The method of claim 8, further comprising:
input in MEMO can be used later for searching and finding members containing those keywords, executed from People, Dating, Places, Public Chat or Private Chat;

10. The method of claim 3, further comprising:
if user selects Chat (Public or Private) from the menu bar, user will see chat that is within a specified radius around the selection of base coordinates using a combination of filters, sorted by date with most recent at the bottom;

11. The method of claim 10, further comprising:
user is given input options for chat communication that include: distance (0, 1, 2, 5, 10, 25, 50, 100, 20000), units of distance (mi, km), base location for proximity search (home, work, other or location), Show dropdown [combination of home, work, other or location address locations to be displayed], user type (Stranger, Contact, Favorite, and/or themselves), dropdown [Interest, Occupation, First Name, Memo, Category, Subject, Comment, Username], dropdown [Exactly, Contains, Starts with], keyword, dropdown [People, Places], online (y/n), can meet now (y/n), VIP (y/n), picture (y/n) and search button;

12. The method of claim 10, further comprising:
user may click on a star in left margin to select the current view as a favorite;
this is followed by a breadcrumb showing the current view of the 16 view chat;
user may click on favorites button (star in right margin) to view/hide their list of favorite chats;

13. The method of claim 12, further comprising:
user can select sort option for the favorites to be either by input date, most recent selection, most often selection or alphabetical;

14. The method of claim 10, further comprising:
if user clicks on a picture, they see a mini profile of the selected member which shows first name, username, online status, can meet now status, membership status, mood, occupation (if disclosed), one or more interests to fit one line, distance away and symbol [home, work, other, location], city and country (full address if place), public chat button, and private chat button; by clicking on first name if person (business name if business), user is directed to that user's full profile, or by clicking on Public Chat or Private Chat, user is directed to that type of chat with that person;

15. The method of claim 10, further comprising:
user may isolate chat by clicking on category or subject associated with that post to only show that type of category or subject;

16. The method of claim 15, further comprising:
if user has selected a category or subject view, they may then select the other to go into a category-subject view;

17. The method of claim 10, further comprising:
in Chat, one picture is shown if that user is speaking to everyone in the world and two pictures are shown if the first person is speaking to the second person;

18. The method of claim 10, further comprising:
in the input area of chat, the user may select category dropdown, subject, comment, language, chat type dropdown (Advanced shows category, subject and comment inputs; Basic shows comment input only), and they can see time zone and input counter;

19. The method of claim 3, further comprising:
sponsor can see the membership and payment status of members they have sponsored by navigating to Lookup Referral—People or Lookup Referral—Places.
